(19) United States
(12) Patent Application Publication
(10) Pub. No.: US 2026/0267374 A1
(43) Pub. Date: Sep. 10, 2026

(54) ELECTRONIC DEVICE

(71) Applicant: NINTENDO CO., LTD., Kyoto-shi (JP)

(72) Inventors: Yuya OKAZAKI, Kyoto-shi (JP); Hideaki KAMATA, Kyoto-shi (JP)

(21) Appl. No.: 19/664,737

(22) Filed: Apr. 30, 2026

Related U.S. Application Data
(63) Continuation of application No. PCT/JP2023/039694, filed on Nov. 2, 2023.

(51) Int. Cl. G06F 1/16; G06F 1/18; G06F 1/20

(52) U.S. Cl. CPC G06F 1/1635; G06F 1/1637; G06F 1/189; G06F 1/203; G06F 2200/201

(57) ABSTRACT

The electronic device includes a metal frame which has a first surface and a second surface positioned on mutually opposite sides, a battery arranged on the first surface, a substrate arranged on the second surface, and a housing in which the metal frame, the battery, and the substrate are accommodated. The substrate faces the battery via the metal frame.

### CROSS-REFERENCE TO RELATED APPLICATION

This application is a continuation application of International Patent Application No. PCT/JP2023/039694 filed on Nov. 2, 2023, the entire contents of which are incorporated herein by reference.

### TECHNICAL FIELD

The present disclosure relates to an electronic device.

### BACKGROUND AND SUMMARY

Conventionally, in an electronic device in which a battery and a substrate are accommodated in a housing, arranging the battery and substrate side-by-side in the width direction of the electronic device is known. In such a configuration, the size of the electronic device in the width direction becomes large when the necessary area for the battery and substrate is secured.

On the other hand, in another prior art, a battery and a substrate are accommodated in a housing such that the battery and the substrate face each other in the thickness direction of a mobile phone.

However, in the latter configuration, a heat diffusion sheet is provided between the substrate and the battery, whereby heat can be transferred between the substrate and the battery. Thus, heat is transferred from the substrate, which generates more heat, to the battery, potentially causing heat to concentrate in the battery. Therefore, even if the electronic device can be reduced in size, there is room for improvement in the heat dissipation performance thereof.

Certain examples of the present disclosure are as follows.
(1) An electronic device comprising: a metal frame which has a first surface and a second surface positioned on mutually opposite sides; a battery arranged on the first surface; a substrate arranged on the second surface; and a housing in which the metal frame, the battery, and the substrate are accommodated, wherein the substrate faces the battery via the metal frame.
(2) The electronic device described in above (1), wherein the metal frame has a first wall part which protrudes from the first surface so as to surround the battery.
(3) The electronic device described in above (1) or (2), further comprising a fan which is arranged on the second surface at a position different from the substrate and is accommodated in the housing, wherein the fan faces the battery via the metal frame.
(4) The electronic device described in above (3), wherein the metal frame has a second wall part which protrudes from the second surface so as to surround the fan.
(5) The electronic device described in above (3) or (4), wherein the housing has an air intake and an exhaust port, and the air intake and the exhaust port are each arranged at a position closer to the fan than the battery in a direction perpendicular to the substrate.
(6) The electronic device described in any one of above (1) to (5), wherein the metal frame is electrically connected to a ground pattern of the substrate.
(7) The electronic device described in any one of above (1) to (6), further comprising: a display; and a battery cover covering the battery, wherein the display is provided in the housing such that the battery is positioned between the display and the metal frame, and the battery cover is provided between the display and the battery.
(8) The electronic device described in above (7), further comprising a cushioning material provided between the battery cover and the battery, wherein the cushioning material has a lower modulus of elasticity than the battery cover.
(9) The electronic device described in any one of above (1) to (6), further comprising a display, wherein the display is provided in the housing such that the substrate is positioned between the display and the metal frame.

### BRIEF DESCRIPTION OF DRAWINGS

Embodiments of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a front perspective view of an electronic device according to a first embodiment of the present disclosure.

FIG. 2 is a bottom view of the electronic device according to the first embodiment of the present disclosure.

FIG. 3 is an exploded perspective view of the electronic device according to the first embodiment of the present disclosure.

FIG. 4 is a rear view of the electronic device according to the first embodiment of the present disclosure.

FIG. 5A is a front perspective view of a metal frame.

FIG. 5B is a rear perspective view of the metal frame.

FIG. 6 is a cross-sectional view of the electronic device taken along the line A-A of FIG. 4.

FIG. 7 is an exploded perspective view of an electronic device according to a second embodiment of the present disclosure.

### DETAILED DESCRIPTION

The embodiments of the present disclosure will be described in detail below with reference to the drawings. In the following description, identical constituent elements have been assigned the same reference sign.

### First Embodiment

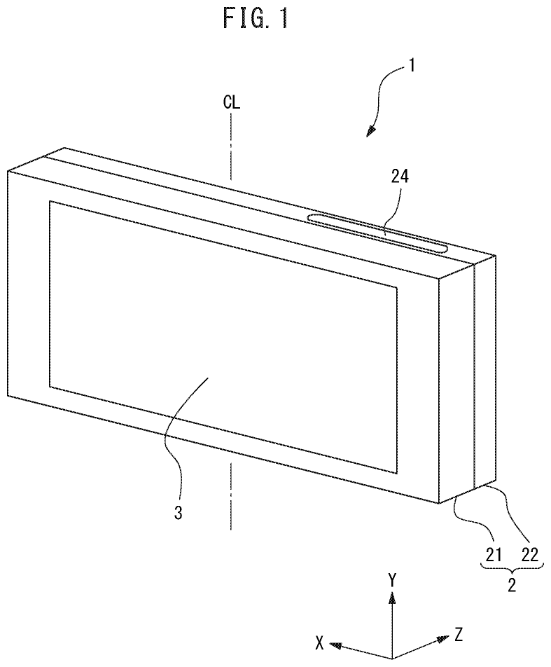

Initially, a first embodiment of the present disclosure will be described with reference to FIGS. 1 to 6. FIG. 1 is a front perspective view of the electronic device 1 according to the first embodiment of the present disclosure. In the present embodiment, the electronic device 1 is portable electronic device, such as a portable game console, a tablet terminal, a smartphone, a mobile monitor, an e-book reader, etc. The electronic device 1 has a substantially rectangular parallelepiped shape and is held by the user when used by the user.

In the present description, the configuration of the electronic device 1 will be described using an XYZ Cartesian coordinate system set for the electronic device 1. The XYZ Cartesian coordinate system defines the orientation of the electronic device 1 in a state in which the electronic device 1, held by the user, faces the user. Specifically, when the electronic device 1, held by the user, faces the user, the X-axis direction corresponds to the left-right direction of the electronic device 1, the Y-axis direction corresponds to the up-down direction of the electronic device 1, and the Z-axis direction corresponds to the depth direction (thickness direction) of the electronic device 1. The left side surface and the right side surface of the electronic device 1 are separated in the X-axis direction, the top surface and the bottom surface of the electronic device 1 are separated in the Y-axis direction, and the front surface and the back surface of the electronic device 1 are separated in the Z-axis direction.

As shown in FIG. 1, the electronic device 1 includes a housing 2 and a display 3. The housing 2, together with the display 3, forms the outer surface of the electronic device 1. In the present embodiment, the length of the electronic device 1 and the housing 2 in the X-axis direction is greater than the length of the electronic device 1 and the housing 2 in the Y-axis direction. Thus, the X-axis direction corresponds to the longitudinal direction of the electronic device 1 and the housing 2, and the Y-axis direction corresponds to the short-side direction of the electronic device 1 and the housing 2. Furthermore, the left side surface, right side surface, top surface, bottom surface, front surface, and back surface of the housing 2 correspond to the left side surface, right side surface, top surface, bottom surface, front surface, and back surface of the electronic device 1, respectively.

In the present embodiment, the housing 2 includes a first housing 21 and a second housing 22, and is formed by combining the first housing 21 and the second housing 22. The first housing 21 and the second housing 22 define the internal space of the housing 2 when the first housing 21 and the second housing 22 are combined. For example, the first housing 21 and the second housing 22 are each made of resin and are formed by injection molding or the like.

As shown in FIG. 1, in the Z-axis direction, the first housing 21 is arranged at the front surface side of the electronic device 1, and the second housing 22 is arranged at the rear surface side of the electronic device 1. The front surfaces of the electronic device 1 and the housing 2 face the user when the electronic device 1 is used by the user. The front surface side of the electronic device 1 refers to the area closer to the front surface of the electronic device 1 than to the rear surface of the electronic device 1, and the rear surface side of the electronic device 1 refers to the area closer to the rear surface of the electronic device 1 than to the front surface of the electronic device 1.

The display 3 displays visual information (text, images, etc.) to the user. Thus, the display 3 is provided in the housing 2 such that the display surface thereof is visible to the user. Accordingly, the display 3 is arranged at the front surface side of the electronic device 1 and is provided in the first housing 21. In the present embodiment, the display 3 is arranged in the central region of the electronic device 1 in the X-axis and Y-axis directions. The display 3 is, for example, a liquid crystal display (LCD), an organic EL display, or the like. Note that the display 3 may be a touch panel display.

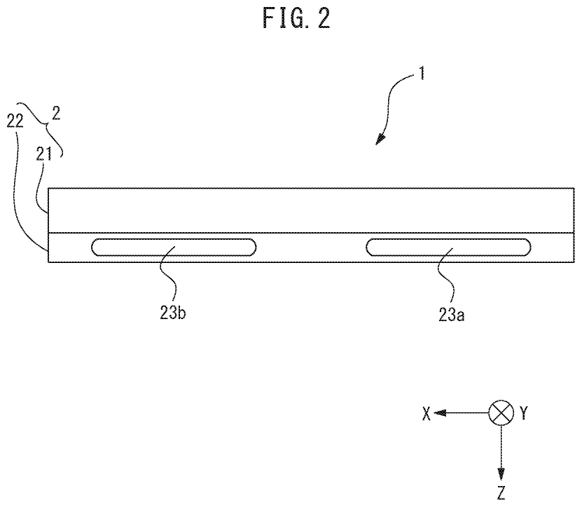

FIG. 2 is a bottom view of the electronic device 1 according to the first embodiment of the present disclosure. As shown in FIGS. 1 and 2, the housing 2 has an air intake 23 and an exhaust port 24. The air intake 23 is formed in the bottom surface of the housing 2, and the exhaust port 24 is formed in the top surface of the housing 2. In the present embodiment, the air intake 23 and the exhaust port 24 are arranged at the rear surface side of the electronic device 1 in the Z-axis direction and are formed in the second housing 22.

In the present embodiment, the air intake 23 includes a first air intake 23a and a second air intake 23b. The first air intake 23a and the second air intake 23b have the same shape and are arranged in positions which are symmetrical with respect to the left-right center line CL of the electronic device 1. In the X-axis direction, the first air intake 23a is arranged at the right side of the electronic device 1, and the second air intake 23b is arranged at the left side of the electronic device 1. As shown in FIG. 1, the left-right center line CL of the electronic device 1 refers to the line dividing the electronic device 1 in the X-axis direction (left-right direction of the electronic device 1). Furthermore, the right side of the electronic device 1 refers to the area closer to the right side surface of the electronic device 1 than to the left side surface of the electronic device 1, and the left side of the electronic device 1 refers to the area closer to the left side surface of the electronic device 1 than to the right side surface of the electronic device 1.

The exhaust port 24 is arranged at the right side of the electronic device 1 in the X-axis direction and faces the first air intake 23a in the Y-axis direction. Accordingly, the first air intake 23a and the exhaust port 24 are arranged so as to overlap each other when viewed from the Y-axis direction. The first air intake 23a, the second air intake 23b, and the exhaust port 24 each connect the internal space of the housing 2 to the outside of the housing 2. In the present embodiment, the first air intake 23a, the second air intake 23b, and the exhaust port 24 are each formed as a single slit-shaped hole extending in the X-axis direction.

The configurations (shape, arrangement, etc.) of the first air intake 23a, the second air intake 23b, and the exhaust port 24 are merely exemplary, and the first air intake 23a, the second air intake 23b, and the exhaust port 24 may each have other configurations. For example, at least one of the first air intake 23a, the second air intake 23b, and the exhaust port 24 may be formed as a plurality of holes spaced apart in the X-axis direction. Alternatively, the first air intake 23a and the second air intake 23b may be formed as a single hole.

Furthermore, the exhaust port 24 may be arranged in the central region of the electronic device 1 in the X-axis direction. Either of the first air intake 23a and the second air intake 23b may be omitted. In this case, the air intake 23 may be arranged in the central region of the electronic device 1 in the X-axis direction. At least one of the air intake 23 and the exhaust port 24 may be formed in the first housing 21.

Alternatively, the air intake 23 may be formed in the upper surface of the housing 2, and the exhaust port 24 may be formed in the lower surface of the housing 2. Alternatively, one of the air intake 23 and exhaust port 24 may be formed in the right side surface of the housing 2, and the other of the air intake 23 and exhaust port 24 may be formed in the left side surface of the housing 2.

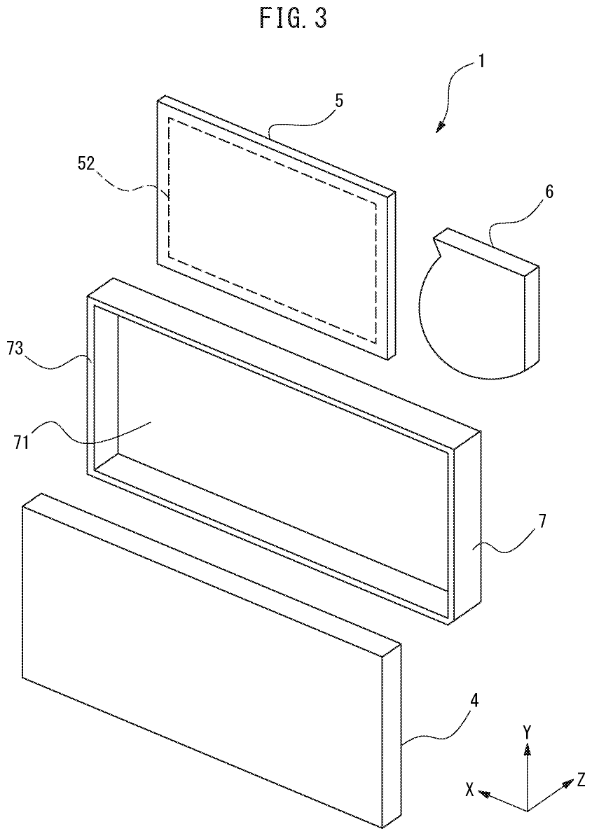

FIG. 3 is an exploded perspective view of the electronic device 1 according to the first embodiment of the present disclosure. FIG. 3 shows the internal components of the electronic device 1, and the housing 2 and the display 3 of the electronic device 1 are omitted. As shown in FIG. 3, the electronic device 1 includes a battery 4, a substrate 5, a fan 6, and a metal frame 7 as internal components accommodated in the housing 2. Accordingly, the battery 4, the substrate 5, the fan 6, and the metal frame 7 are arranged in the internal space of the housing 2.

The battery 4 has a substantially rectangular parallelepiped shape and stores power. The electronic device 1 is powered by the electricity stored in the battery 4. The battery 4 is a rechargeable secondary battery which can be charged by an external power source, such as a lithium-ion battery or a nickel-metal hydride battery. The battery 4 supplies power to the drive components of the electronic device 1, such as the display 3 and the fan 6, via the substrate 5.

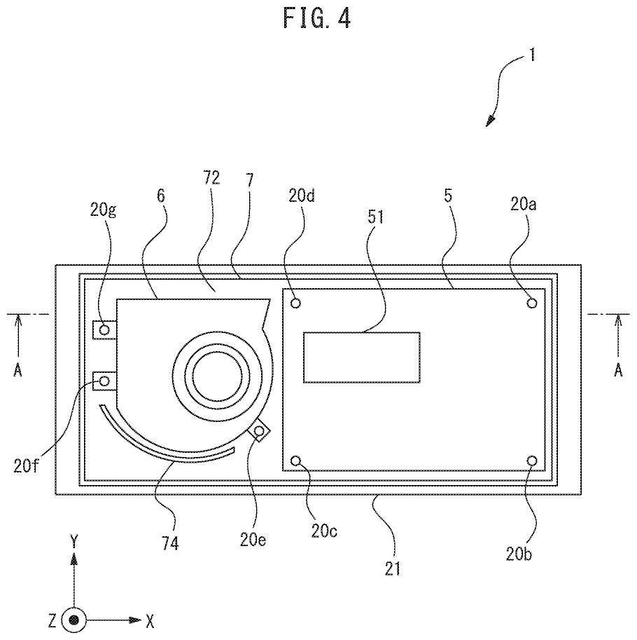

FIG. 4 is a rear view of the electronic device 1 according to the first embodiment of the present disclosure. FIG. 4 shows the internal components of the electronic device 1, and the electronic device 1 from which the second housing 22 has been removed is shown. The substrate 5 is, for example, a thin plate-shaped multilayer substrate, and a plurality of electronic components (for example, a system on a chip (SoC) 51, etc.) are mounted on the substrate 5.

Furthermore, as shown in FIG. 3, the substrate 5 has a ground pattern 52 which is electrically connected to the ground potential of the electronic device 1. The ground pattern 52 is composed of a conductor such as copper or silver and is formed by a common processing method (for example, etching) for providing wiring patterns on a printed circuit substrate. In the present embodiment, the ground pattern 52 is arranged in one of the plurality of layers of the substrate 5.

The fan 6 is powered by electricity stored in the battery 4 and generates airflow from the air intake 23 (the first air intake 23a and the second air intake 23b) to the exhaust port 24. When the fan 6 is powered, air is drawn from outside the housing 2 through the air intake 23 to the fan 6, and air is blown out from the fan 6. The air blown out from the fan 6 is discharged to the outside of the housing 2 through the exhaust port 24. Thus, the air intake 23 functions as an inlet for air drawn into the fan 6, and the exhaust port 24 functions as an outlet for air blown out from the fan 6. The fan 6 cools the battery 4, the substrate 5, and the metal frame 7 by blowing air.

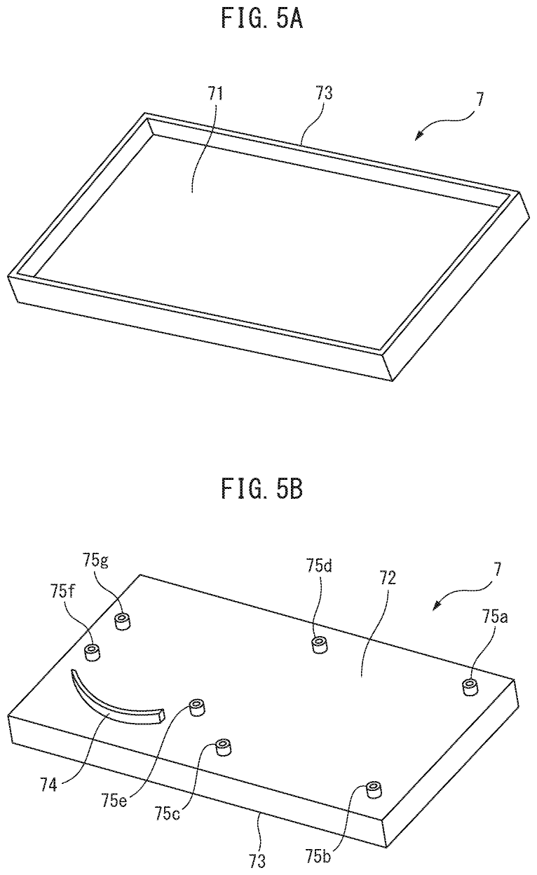

FIG. 5A is a front perspective view of the metal frame 7, and FIG. 5B is a rear perspective view of the metal frame 7. The metal frame 7 is made of metal (for example, magnesium (Mg), aluminum (Al), etc.) and holds the battery 4, the substrate 5, and the fan 6. The metal frame 7 is formed by die casting, press molding, or the like, and is attached to the housing 2, for example, by fastening members such as screws.

The metal frame 7 has a first surface 71 and a second surface 72 positioned on mutually opposite sides. As shown in FIGS. 3 and 4, the first surface 71 is arranged at the front surface side of the electronic device 1, and the second surface 72 is arranged at the rear surface side of the electronic device 1. The battery 4 is arranged on the first surface 71 of the metal frame 7. The battery 4 is attached to the first surface 71, for example, by an adhesive member, such as double-sided tape or adhesive.

As shown in FIGS. 3 and 5A, the metal frame 7 has a first wall part 73 which protrudes from the first surface 71 toward the front surface side of the electronic device 1. The first wall part 73 protrudes from the first surface 71 so as to surround the battery 4. Thus, the first wall part 73 can protect the battery 4 and reduce the impact exerted on the battery 4 when the electronic device 1 is dropped, etc. Furthermore, heat from the battery 4 can be transferred to the metal frame 7 not only from the bottom surface of the battery 4, which is placed on the first surface 71, but also from the side surface of the battery 4 facing the first wall part 73, thereby improving the heat dissipation performance of the battery 4. In the present description, the phrase “a wall part surrounds a member” means that the wall part is provided around at least a portion of the member.

In the present embodiment, the height of the first wall part 73 is equal to the thickness of the battery 4, and the battery 4 is accommodated by the metal frame 7. Thus, the metal frame 7 can provide robust protection for the battery 4, and heat can be efficiently transferred from the battery 4 to the metal frame 7. Note that the phrase “height of the first wall part 73 is equal to the thickness of the battery 4” means that the values of the two are within a range in which they are substantially equal, and there is substantially no step between the first wall part 73 and the battery 4.

On the other hand, as shown in FIG. 4, the substrate 5 and fan 6 are arranged on the second surface 72 of the metal frame 7. The fan 6 is arranged on the second surface 72 at a position different from the substrate 5. In the present embodiment, in the X-axis direction, the fan 6 is arranged in the region to the left of the substrate 5, and in the Y-axis direction, the fan 6 is arranged between the first air intake 23a and the exhaust port 24 and faces the first air intake 23a and the exhaust port 24. Accordingly, the fan 6 is arranged in a position which overlaps with the first air intake 23a and the exhaust port 24 when viewed from the Y-axis direction. As a result, the airflow from the first air intake 23a to the fan 6 and the airflow from the fan 6 to the exhaust port 24 can be facilitated, whereby the cooling effect of the fan 6 is increased.

In the present embodiment, the substrate 5 is attached to the second surface 72 by fastening screws 20a to 20d, and the fan 6 is attached to the second surface 72 by fastening screws 20e to 20g. The fastening screws 20a to 20g are each inserted into female threading 75a to 75g provided on the second surface 72. As shown in FIG. 5B, the metal frame 7 has the female threading 75a to 75g, and the female threading 75a to 75g protrude from the second surface 72 to the rear surface side of the electronic device 1. Note that the female threading 75a to 75g may be nuts attached to the second surface 72 or the like.

In the present embodiment, the metal frame 7 is electrically connected to the ground pattern 52 of the substrate 5 via the fastening screws 20a to 20d. As a result, the grounding of the substrate 5 is stabilized. Alternatively, the ground pattern of the substrate 5 may be provided on the outer surface of the substrate 5, and the metal frame 7 may be electrically connected to the ground pattern of the substrate 5 by directly contacting the ground pattern of the substrate 5 with the metal frame 7.

The number and arrangement of the fastening screws 20a to 20g and the female threading 75a to 75g may differ from those described above. Furthermore, the types of the fastening screws 20a to 20d for securing the substrate 5 and the fastening screws 20e to 20g for securing the fan 6 may be different. At least one of the substrate 5 and the fan 6 may be attached to the second surface 72 by an adhesive member such as double-sided tape or adhesive.

Furthermore, as shown in FIG. 5B, the metal frame 7 has a second wall part 74 which protrudes from the second surface 72 towards the rear surface side of the electronic device 1. The second wall part 74 protrudes from the second surface 72 so as to surround the fan 6. Thus, the fan 6 can be protected by the second wall part 74, and the impact exerted on the fan 6 when the electronic device 1 is dropped, etc., can be reduced.

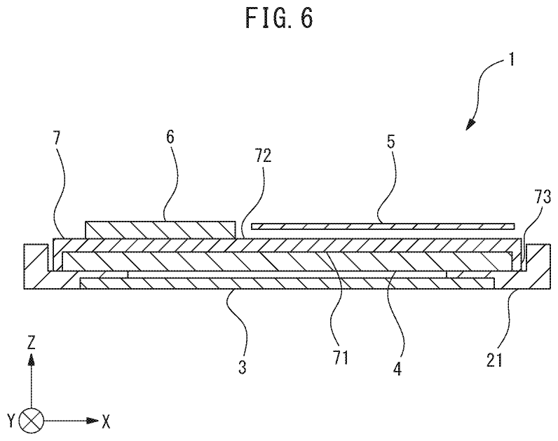

FIG. 6 is a cross-sectional view of the electronic device 1 taken along line A-A of FIG. 4. As shown in FIG. 6, the metal frame 7 is arranged between the battery 4 and the substrate 5 in the Z-axis direction, and the substrate 5 faces the battery 4 via the metal frame 7 in the Z-axis direction. Accordingly, the substrate 5 is arranged in a position which overlaps with the battery 4 when viewed from the Z-axis direction, and is spaced apart from the battery 4 in the Z-axis direction. Thus, the battery 4 and the substrate 5 are arranged in different XY planes (planes perpendicular to the Z-axis) within the housing 2. As a result, the size of the electronic device 1 can be reduced while securing the area for the battery 4 and the substrate 5.

Furthermore, heat from the battery 4 is transferred to the metal frame 7 from one side of the metal frame 7, and heat from the substrate 5 is transferred to the metal frame 7 from the other side of the metal frame 7. Thus, the metal frame 7 can thermally isolate the battery 4 and the substrate 5, whereby the heat dissipation performance of the electronic device 1 is improved. Therefore, according to the present embodiment, in the electronic device 1 including the battery 4 and the substrate 5, both size reduction and improved heat dissipation performance of the electronic device 1 can be achieved. Furthermore, in the present embodiment, the metal frame 7 can be cooled by the air blown by the fan 6, further improving the heat dissipation performance of the electronic device 1.

Furthermore, as shown in FIG. 6, the metal frame 7 is arranged between the battery 4 and the fan 6 in the Z-axis direction, and the fan 6 faces the battery 4 via the metal frame 7 in the Z-axis direction. Accordingly, the fan 6 is arranged in a position which overlaps the battery 4 when viewed from the Z-axis direction, and is spaced apart from the battery 4 in the Z-axis direction. Thus, the battery 4 and the fan 6 are arranged in different XY planes within the housing 2. On the other hand, the fan 6 is arranged adjacent to the substrate 5 in the X-axis direction, and the substrate 5 and the fan 6 are arranged in the same XY plane within the housing 2. As a result, the area of the battery 4 can be made greater than the area of the substrate 5, whereby the capacity of the battery 4 can be secured. Furthermore, since the fan 6 is provided adjacent to the substrate 5, which generates more heat than the battery 4, more air can be directed to the substrate 5 than to the battery 4, whereby the heat dissipation effect of the electronic device 1 can be enhanced.

Furthermore, as described above, the air intake 23 and the exhaust port 24 are formed in the second housing 22 and are arranged in the rear surface side of the electronic device 1. Thus, in the present embodiment, the air intake 23 and the exhaust port 24 are arranged in positions closer to the fan 6 and the substrate 5 than to the battery 4 in the Z-axis direction, that is, in the direction perpendicular to the substrate 5. As a result, the airflow from the air intake 23 to the fan 6 and the airflow from the fan 6 to the exhaust port 24 can be facilitated, whereby the cooling effect of the fan 6 can be improved.

### Second Embodiment

The electronic device according to the second embodiment is substantially identical to the electronic device according to the first embodiment, except for the points described below. Thus, the second embodiment of the present disclosure will be described below focusing on the differences from the first embodiment.

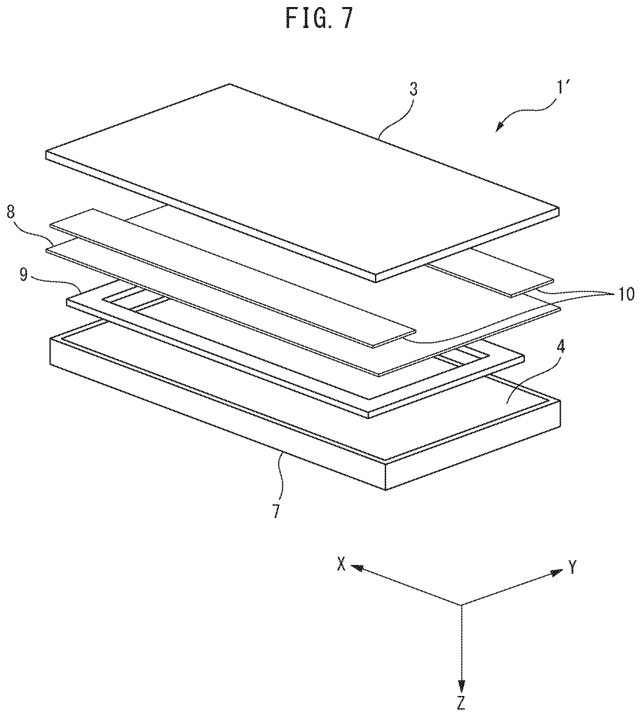

FIG. 7 is an exploded perspective view of an electronic device 1′ according to a second embodiment of the present disclosure. FIG. 7 shows some of the components of the electronic device 1′, and the housing 2, the substrate 5, and the fan 6 of the electronic device 1′ have been omitted.

In the similar manner to the first embodiment, in the electronic device 1′, the display 3 is provided in the housing 2 such that the battery 4 is positioned between the display 3 and the metal frame 7. Accordingly, the display 3 and the battery 4 are arranged in a position closer to the front surface than the metal frame 7. On the other hand, unlike the first embodiment, the electronic device 1′ further includes a battery cover 8, a first cushioning material 9, and a second cushioning material 10. The battery cover 8, the first cushioning material 9, and the second cushioning material 10 are arranged between the display 3 and the battery 4 and are accommodated in the housing 2.

The battery cover 8 has a thin plate shape and covers the battery 4. The battery cover 8 is made of, for example, stainless steel (SUS). The battery cover 8 prevents direct contact between the battery 4 and the display 3, thereby reducing the impact exerted on the battery 4 and the display 3 when the electronic device 1′ is dropped, etc. Therefore, the battery cover 8 can increase the strength of the battery 4 and the display 3. Furthermore, even if the battery cover 8 impedes heat dissipation from the battery 4, in the electronic device 1′, by releasing heat from the battery 4 to the metal frame 7, the heat dissipation performance of the battery 4 can be secured.

The first cushioning material 9 is provided between the battery cover 8 and the battery 4 and has a lower modulus of elasticity than the battery cover 8. The first cushioning material 9 is composed of a cushioning material (for example, urethane foam). The first cushioning material 9 has a hollow rectangular shape and covers the periphery of the battery 4. The first cushioning material 9 fills the gap between the battery cover 8 and the battery 4, preventing dust and other debris from entering this gap. Furthermore, the first cushioning material 9 absorbs impact between the battery cover 8 and the battery 4, further reducing the impact exerted on the battery 4 when electronic device 1′ is dropped, etc. Furthermore, a rectangular cavity is formed in the center of the first cushioning material 9.

The second cushioning material 10 is provided between the battery cover 8 and the display 3 and has a lower modulus of elasticity than the battery cover 8. The second cushioning material 10 is composed of a cushioning material (for example, urethane foam). The second cushioning material 10 is constituted by a pair of members extending in the X-axis direction and covers the upper and lower edges of the display 3. The second cushioning material 10 fills the gap between the battery cover 8 and the display 3, preventing dust and other debris from entering this gap. Furthermore, the second cushioning material 10 absorbs impact between the battery cover 8 and the display 3, reducing the impact exerted on the display 3 when the electronic device 1′ is dropped, etc.

Note that the first cushioning material 9 may cover a portion of the periphery of the battery 4. For example, the first cushioning material 9 may be constituted by a pair of members extending in the X-axis direction, in the similar manner to the second cushioning material 10. The second cushioning material 10 may cover the entire periphery of the display 3. For example, the second cushioning material 10 may have a hollow rectangular shape, in the similar manner to the first cushioning material 9. Further, at least one of the first cushioning material 9 and the second cushioning material 10 may be omitted.

### Other Embodiments

Though preferred embodiments of the present disclosure have been described above, the present disclosure is not limited to these embodiments, and various modifications and changes can be made within the scope of the claims. For example, the housing 2 may be formed from three or more members (for example, a front member, a rear member, and a side member, etc.). Further, in addition to the display 3, a power button, operation buttons, speaker holes, USB ports, etc., may be provided at the outer surface of the housing 2.

Alternatively, the first surface 71 of the metal frame 7 may be arranged at the rear surface side of the electronic device 1, and the second surface 72 of the metal frame 7 may be arranged at the front surface side of the electronic device 1. In this case, the substrate 5 and the fan 6 are arranged at the front surface side of the electronic device 1, and the battery 4 is arranged at the rear surface side of the electronic device 1. Accordingly, the display 3 is provided in the housing 2 such that the substrate 5 and the fan 6 are positioned between the display 3 and the metal frame 7. In this arrangement, access to the battery 4 from the rear surface side of the electronic device 1 can be facilitated, whereby replacement or repair of the battery 4 can be facilitated. Note that in this arrangement, in which the fan 6 is arranged at the front surface side of the electronic device 1, the air intake 23 and the exhaust port 24 may be formed in the first housing 21 and be arranged at the front surface side of the electronic device 1.

Furthermore, the display 3 may be omitted from the electronic device 1. Furthermore, the fan 6 may be omitted from the electronic device 1, 1′. In this case as well, by collecting the heat from the battery 4 and the substrate 5 into the metal frame 7, the heat dissipation performance of the electronic device 1, 1′ can be improved.

1. An electronic device comprising:
a metal frame which has a first surface and a second surface positioned on mutually opposite sides;
a battery arranged on the first surface;
a substrate arranged on the second surface; and
a housing in which the metal frame, the battery, and the substrate are accommodated, wherein
the substrate faces the battery via the metal frame.

2. The electronic device according to claim 1, wherein the metal frame has a first wall part which protrudes from the first surface so as to surround the battery.

3. The electronic device according to claim 1, further comprising a fan which is arranged on the second surface at a position different from the substrate and is accommodated in the housing, wherein
the fan faces the battery via the metal frame.

4. The electronic device according to claim 3, wherein the metal frame has a second wall part which protrudes from the second surface so as to surround the fan.

5. The electronic device according to claim 3, wherein the housing has an air intake and an exhaust port, and
the air intake and the exhaust port are each arranged at a position closer to the fan than the battery in a direction perpendicular to the substrate.

6. The electronic device according to claim 1, wherein the metal frame is electrically connected to a ground pattern of the substrate.

7. The electronic device according to claim 1, further comprising:
a display; and
a battery cover covering the battery, wherein
the display is provided in the housing such that the battery is positioned between the display and the metal frame, and
the battery cover is provided between the display and the battery.

8. The electronic device according to claim 7, further comprising a cushioning material provided between the battery cover and the battery, wherein
the cushioning material has a lower modulus of elasticity than the battery cover.

9. The electronic device according to claim 1, further comprising a display, wherein
the display is provided in the housing such that the substrate is positioned between the display and the metal frame.
